(19) United States
(12) Patent Application Publication
(10) Pub. No.: US 2007/0147950 A1
(43) Pub. Date: Jun. 28, 2007

(54) FLUID APPLICATOR ASSEMBLY

(76) Inventor: Michael B. Puczkowski, Cleveland, OH (US)

Correspondence Address: RANKIN, HILL, PORTER & CLARK LLP, 4080 ERIE STREET, WILLOUGHBY, OH, 44094-7836, US

(21) Appl. No.: 11/539,351

(22) Filed: Oct. 6, 2006

Related U.S. Application Data
(60) Provisional application No. 60/724,238, filed on Oct. 7, 2005.

(51) Int. Cl. B43M 11/02; A46B 15/00

(52) U.S. Cl. 401/219; 401/15

(57) ABSTRACT

A fluid applicator assembly includes a frame that receives a fluid supply assembly. The frame is generally U-shaped, including a base that has first and second arms extending from free ends thereof. The base receives a bulkhead fitting through which pressurized fluid is supplied to the fluid supply assembly and to which an elongated handle may be secured. Each of the arms has an elongated slot formed therein. The fluid supply assembly includes a T-shaped connector, a pair of flexible tubes, a pair of L-shaped connectors, and a rigid fluid distribution tube or manifold. The T-shaped connector is received in the bulkhead connector and is connected to a first end of the flexible tubes so as to direct pressurized fluid into each of the flexible tubes. The opposite or second end of each of the flexible tubes is connected to a barbed end of one of the L-shaped connectors. A threaded or opposite end of the L-shaped connectors extends through a split washer, the elongated slot in the frame, and is sealingly threaded into an associated end of the rigid fluid distribution tube. The fluid distribution tube receives pressurized fluid from the flexible tubes and directs same to outlets formed through an outer surface thereof.

### CROSS REFERENCE TO RELATED APPLICATION

The present application claims priority to U.S. Provisional Application 60/724,238, filed Oct. 7, 2005, the disclosure of which is incorporated by reference herein in its entirety.

### BACKGROUND OF THE INVENTION

1. Field of the Invention

The present invention relates to fluid applicators, such as paint dispensers that supply a pressurized flow of paint to a roller assembly.

2. Description of Related Art

Fluid applicators for supplying a pressurized flow of paint to a roller assembly are known in the art. A first kind of such fluid applicators provides the paint to an interior of the paint roller, and is generally unrelated to the present invention. A second kind of such fluid applicators supplies paint to adjacent an exterior surface of the roller.

The second type of fluid applicators tends to be relatively complex, are difficult or impossible to adjust, and are therefore not easily assembled or conveniently used. Further, the second type of fluid applicator is difficult to disassemble for cleaning. The present invention is directed toward an optimized fluid applicator assembly that has relatively few parts, is easily disassembled for cleaning, and is readily assembled for use.

Therefore, there exists a need in the art for an improved fluid applicator assembly that is simple to assemble, clean, and maintain, and that is easily adjustable.

### SUMMARY OF THE INVENTION

The present invention is directed toward an improved fluid applicator assembly that is easy to assembly, disassemble, clean, and maintain. The fluid applicator assembly has few parts, and is easily inspected and cleaned.

In accordance with the present invention, the fluid applicator includes a frame that receives a fluid supply assembly.

The frame is generally U-shaped, including a base that has first and second arms extending from free ends thereof. The base receives the bulkhead fitting through which pressurized fluid is supplied to the fluid supply assembly and to which an elongated handle may be secured. Each of the arms has an elongated slot formed therein.

The fluid supply assembly includes a T-shaped connector, a pair of flexible tubes, a pair of L-shaped connectors, and a rigid fluid distribution tube or manifold. The T-shaped connector is received in the bulkhead connector and is connected to a first end of the flexible tubes so as to direct pressurized fluid into each of the flexible tubes. The opposite or second end of each of the flexible tubes is connected to a barbed end of one of the L-shaped connectors. A threaded or opposite end of the L-shaped connectors extends through a split washer, the elongated slot in the frame, and is threaded into an associated end of the rigid fluid distribution tube.

### BRIEF DESCRIPTION OF THE DRAWINGS

These and further features of the invention will be apparent with reference to the following description and drawings, wherein:

FIG. 1 is a perspective view of the fluid applicator assembly according to the present invention;

FIG. 2 is an exploded perspective view of the fluid applicator assembly; and,

FIG. 3 is a side elevational view of the fluid applicator assembly shown in FIG. 1.

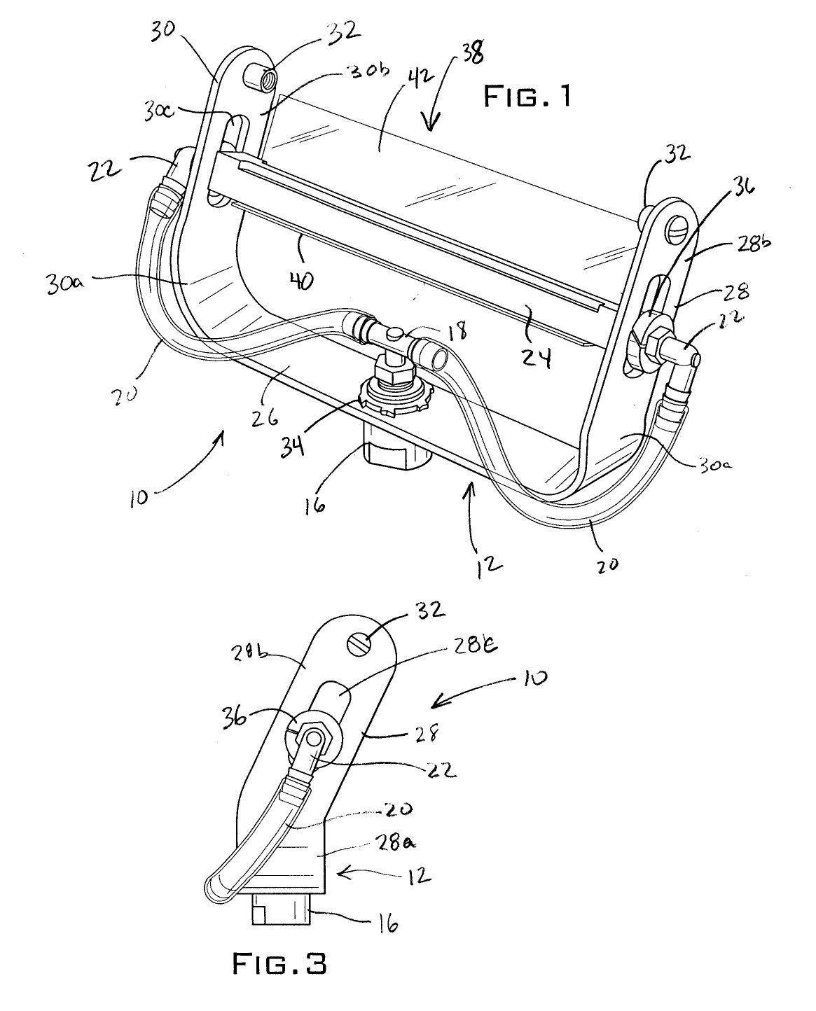

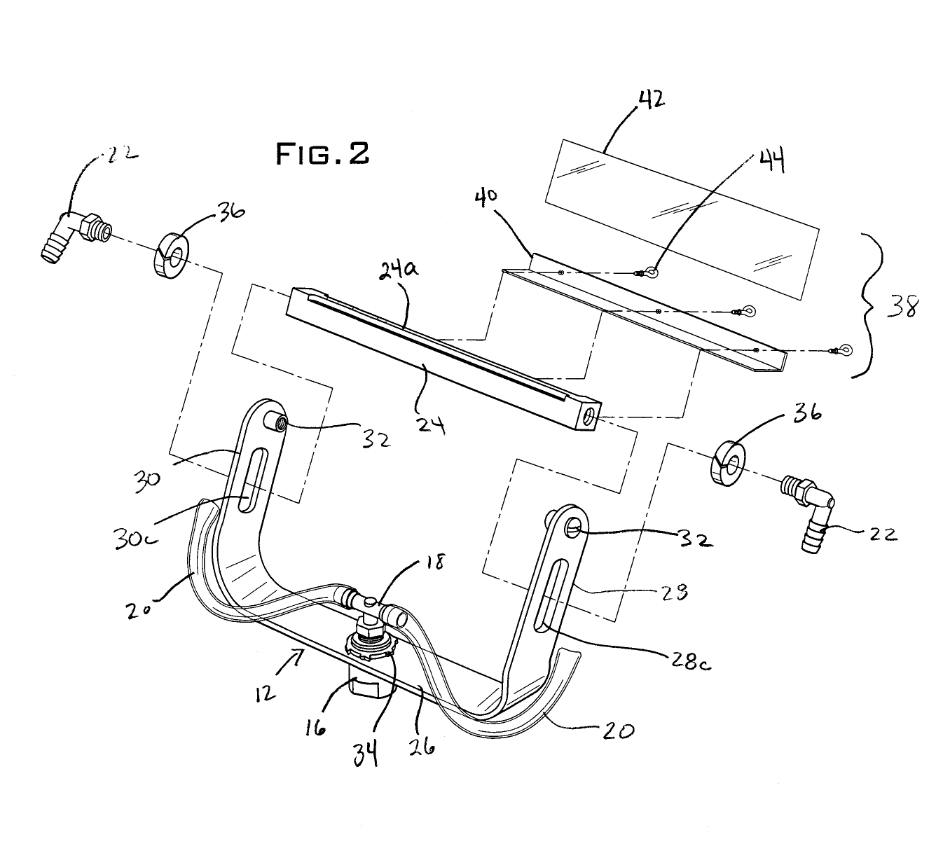

### DETAILED DESCRIPTION OF THE PREFERRED EMBODIMENTS

With reference to the drawing figures, the fluid applicator assembly 10 according to the present invention is shown to include a frame or handle 12 that receives a fluid supply assembly. The fluid supply assembly, to be described hereinafter, includes a bulkhead fitting 16, a T-shaped fitting 18, a pair of flexible tubes or conduits 20, a pair of L-shaped connectors 22, and a relatively rigid fluid distribution tube or manifold 24.

The frame 12 is preferably made from a unitary piece of a durable, rust-resistant metal, such as aluminum or stainless steel. The frame 12 is formed into a generally U-shape, including a base 26 and a pair of arms 28, 30 extending from the base 26. More specifically, the base 26 has first and second ends, with a first arm 28 extending outwardly from the first end and a second arm 30 extending outwardly from the second end. The arms 28, 30 have a proximal portion 28a, 30a that extends generally normal to the length of the base 26, and a distal portion 28b, 30b that extends at an angle to the proximal portion 28a, 30a such that mounting studs 32 provided near free end of the distal portion 28b, 30b, to which a roller assembly (not shown) is secured, are disposed out of the plane of the base 26. Disposing the roller assembly (not shown) in this position facilitates use of the roller assembly in applying paint to a surface.

The distal portion 28b, 30b of each arm 28, 30 has an elongated slotted opening 28c, 30c formed therein. The elongated slotted openings 28c, 30c are aligned with one another, and permit rigid fluid distribution tube or manifold 24 to be adjustably positioned along the length of the arms 28, 30 and secured to the frame 12, as described hereinafter, and thereby permits the distribution manifold 24 to be optimally positioned relative to the roller assembly (not shown).

A hole is formed in the base 26 at about a mid-point thereof between the arms 28, 30. The hole receives the bulkhead fitting 16 through which pressurized fluid is delivered to the fluid distribution assembly and to which an elongated handle or pole (not shown) may be attached.

With reference to the fluid supply assembly, the bulkhead fitting 16 is secured to the frame by a lock nut 34. An inner end of the bulkhead fitting 16 threadingly receives a threaded end of the T-shaped fitting 18, by means of which an incoming pressurized fluid is separated into two parallel flows. Oppositely directed outlets of the T-shaped fitting 18 are barbed and receive the flexible lines 20, which are preferably transparent and extend to the L-shaped fitting 22. Preferably, a barbed first end of the L-shaped fitting 22 is pushed into the free end of the associated flexible tube 20, while a threaded second end of the L-shaped fitting 22 is threadingly and sealingly received in an associated end of the rigid fluid distribution manifold 24. As such, pressurized fluid is provided to each end of the fluid distribution manifold 24 via the flexible tubes 20.

With regard to the mounting of the fluid distribution manifold 24 to the frame 12, it will be appreciated that the split nut 36, which is preferably provided on the outside surface of the frame arm 28, 30 and is forced into engagement with the frame arm 28, 30 adjacent the elongated slot 28c, 30c upon tightening of the L-shaped fitting 22 into the distribution manifold 24, is adapted to spread or separate slightly as the L-shaped fitting 22 is threaded or tightened into the distribution manifold 24 so as to permit a fluid tight engagement between the L-shaped fitting 22 and the manifold 24.

The fluid distribution tube or manifold 24 is preferably formed from a rigid plastic material, such as nylon, and has female-threaded bores at each end, a longitudinal passageway connecting the bores, and a series of small outlet openings extending from an outer side 24a to the longitudinal passageway. Accordingly, pressurized fluid flowing into the longitudinal passageway via the female-threaded bores exits the passageway via the small outlet openings in the outer side 24a. The small openings are preferably directed so as to face toward the roller device, such that fluid flowing through the small openings is deposited or wiped across the roller device, as will be apparent to those skilled in the art.

The fluid distribution tube or manifold 24 has a drip guard assembly 38 secured thereto. Preferably, the drip guard assembly 38 includes an elongated L-shaped mounting bracket 40 and a panel 42, both of which are preferably formed from a transparent plastic material. Mounting screws such as eye-screws 44 extend through the mounting bracket 40 and the panel 42 and are threadingly secured in holes formed in the fluid distribution tube 24 so as to clampingly secure the panel 42 between the mounting bracket 40 and the tube 24. The panel 42 extends away from the tube 24 toward the roller assembly, as will be apparent from the drawings.

It will be appreciated that many of the components of the fluid applicator assembly 10 are readily available so as to be inexpensive to replace. For example, the bulkhead fitting 16, flexible tubes 20, and connectors 18, 22 are all commercially available components, and therefore may be readily replaced. This not only makes the fluid applicator assembly 10 inexpensive to manufacture, but also inexpensive to maintain.

Further, the fluid applicator assembly 10 is easy to assemble and disassemble. The flexible tubes 20 may be simply pulled off of and pushed onto the barbed ends of the T-shaped and L-shaped connectors 18, 22. The T-shaped connector 18 is simply unthreaded from the bulkhead fitting 16. Unthreading of the L-shaped connector 22 from the manifold 24 permits the manifold 24 to be either adjusted along the slotted openings 28c, 30c of the frame 12, or removed from the frame 12 for cleaning. Therefore, it will be appreciated that assembly and disassembly of the fluid applicator assembly is a simple process, and thereby makes cleaning and maintenance of the fluid applicator assembly relatively easy.

What is claimed is:

1. A fluid applicator assembly, comprising:
a generally U-shaped frame having a base and first and second arms extending from opposite ends of the base, each of said arms having an elongated slot formed therein; and,
a fluid supply assembly, said fluid supply assembly comprising:
first and second flexible tubes;
a manifold, said manifold having first and second ends, wherein said first end is fluidly connected to said first flexible tube and said second end being fluidly connected to said second flexible tube;
wherein said manifold is received within said frame between said first and second arms, and wherein said manifold is adjustable along a length of said elongated slots.

2. The fluid applicator assembly according to claim 1, wherein said fluid supply assembly further comprises first and second fittings, said first fitting extending though the elongated slot in the first arm and connecting said first flexible tube to said manifold first end and said second fitting extending through the elongated slot in the second arm and connecting said second flexible tube to said manifold second end, and wherein tightening of said first and second fittings to said manifold secures the manifold to the frame.

3. The fluid applicator assembly according to claim 3, further comprising a split washer disposed between each of the first and second fittings and the first and second arms, said split washer facilitating tightening of the fittings to the manifold.

4. The fluid applicator assembly according to claim 2, further comprising a bulkhead fitting extending through the frame base, said bulkhead fitting having a t-shaped fluid connector received therein whereby fluid passing through said bulkhead fitting is separated into two parallel flows and supplied to said first and second flexible conduits.

5. The fluid applicator assembly according to claim 3, further comprising a bulkhead fitting extending through the frame base, said bulkhead fitting having a t-shaped fluid connector received therein whereby fluid passing through said bulkhead fitting is separated into two parallel flows and supplied to said first and second flexible conduits.

6. The fluid applicator assembly according to claim 5, further comprising a drip guard mounted to said manifold so as to extend in a direction away from said base, said drip guard comprising a mounting bracket and a panel that are releasably fixed to said manifold by screws.
